(19) United States
(12) Patent Application Publication
(10) Pub. No.: US 2011/0261141 A1
(43) Pub. Date: Oct. 27, 2011

(54) LASER ETCHING OF AN ACRYLIC AND POLYVINYLCHLORIDE COMPOSITION, AND LASER ETCHED ARTICLE

(76) Inventors: Darryl J. COSTIN, SR., Westlake, OH (US); Darryl J. Costin, JR., Avon, OH (US); Kimberly L. Ripley, Westlake, OH (US)

(21) Appl. No.: 13/092,283

(22) Filed: Apr. 22, 2011

Related U.S. Application Data
(60) Provisional application No. 61/326,821, filed on Apr. 22, 2010.

(51) Int. Cl. B41J 2/44

(52) U.S. Cl. 347/262

(57) ABSTRACT

A laser-markable acrylic and PVC composition (commonly known as Kydex®) is lased using a CO₂ laser to differentiate a laser etched graphic or pattern from the base material. A discoloration may be controlled to improve an appearance of the graphic or pattern. An embodiment uses a 500 to 2,500 watt CO2 laser to provide a raster or vector graphic pattern on the Kydex® finished part. Yet another embodiment is to use a 500 to 2,500 watt CO₂ laser to provide a seamless raster or vector graphic pattern on a large piece of Kydex® which can then be cut and divided into multiple finished parts. In this case, an embodiment would include providing the necessary software and process controls to insure that the seams between individual parts that make up a larger part are without lines of demarcation.

### CROSS-REFERENCE TO RELATED APPLICATION AND CLAIM OF PRIORITY

This application claims the benefit of priority to U.S. Provisional Patent Application No. 61/326,821 filed Apr. 22, 2010 entitled “A Process to Decorate Kydex® With A Laser Engraving Graphic,” the complete disclosure of which is incorporated herein by reference and to which priority is claimed.

### FIELD OF THE INVENTION

The present invention relates to methods of laser marking an article made of acrylic and polyvinylchloride, and to laser-marked acrylic/polyvinylchloride compositions and laser-marked articles.

### BACKGROUND OF THE INVENTION

Manufactured articles can present large or substantial viewable surface areas. Often it is desirable to apply a graphic design to one or more of these surface areas. Graphic designs include ordered patterns, random non-patterns, discrete simple graphic elements, complex graphical images and the like. Printing, painting, and engraving are just a few examples of techniques that may be employed to apply a graphic design to an article. Engraving may involve routing, pressing, carving, cutting, embossing, or etching the surface of the assembly components to permanently deform or remove surface area material of the article. Laser etching is particularly useful for creating intricate and high quality graphic designs on the surface of an article. The graphic design may be etched into the article surface during its manufacture. A design may be applied after an article has been incorporated as a component to another article or structure. Common articles having substantial surface areas for applying a graphic design are boards, doors, door facings, floors, moldings, siding, and walls.

Laser etching designs, patterns, and other images is well known for small work pieces such as bearings, glass cutlery, plastic components, wood plaques, semi-conductors, etc. These products typically have a small working area, requiring a laser having a relatively small field size such as 4-10 inches or less. To provide fine detailed, high resolution images, a laser having a small spot size is required. The detail of an image lazed with a relatively small spot size, for example, less than 0.4 mm would be much finer than the detail of the image lazed with a coarser spot size of 1.2 mm. With the smaller spot size, the laser can etch about 60 lines per inch for near contiguous lines (where the laser lines touch); whereas, with the larger spot size, the laser can etch about 40 laser lines per inch for near contiguous lines. Because laser spot size increases with field size, high detail, high resolution images can easily be produced on smaller items using a laser with a small field size. Laser etching images on larger work pieces, however, requires a larger field size, which in turn, results in a larger laser spot size and a coarser graphic image. Therefore, fine detail, high resolution graphic images have not been achieved using laser etching over large areas. Lazing etching materials over large areas is required either when large individual materials are lazed or when multiple smaller materials are lazed collectively to achieve higher throughput.

The tradeoff between field size and quality of image has prevented larger work pieces or smaller work pieces lazed together from being laser etched in a cost effective manner, especially when the process requires the etching of high resolution images. Some materials that would benefit from laser etching at larger field sizes include, but are not limited to, aircraft products such as bulkhead laminates, armrests, pull-down trays; and laser-etched advertisements on side and ceiling panels used for mass transit and busses. Holsters and sheaths for firearms can also benefit from such techniques by lazing numerous holsters and sheaths at one time in one large working area. All of these products can readily be made of Kydex®, which is a material made from a combination of acrylic and polyvinylchloride compositions. Kydex® is manufactured by Kydex LLC. Kydex® has unique characteristics including fire retardancy, high impact resistance, rigidity, superior chemical resistance and thermo-formability.

Because of its special properties, Kydex finds application in a wide range of industries. For example, Kydex® is found in: aircraft interiors; mass transit; exhibits and displays; store fixture components; medical products; electrical equipment components; kiosk housings; contract furniture; protective wall covering systems; firearm holsters; knife sheaths; safety helmets; food equipment components; clean room walls and ceilings; military gear, etc.

These products are supplied in a range of colors such as red, blue, tan and black and are rarely decorated due to technical limitations. Since the product is used for exhibit displays and panels, a wood grain pattern is supplied on Kydex® by a very expensive vacuum and membrane pressing process. These processes typically have a preheat step, then a pressure/vacuum step and a cooling step. A membrane press process consists of the following steps:
First a design is routed into medium density fiberboard substrate
Second a heat-activated adhesive is applied to the surface of the material
Third the parts are placed on the vacuum table and a Kydex® sheet is placed over the parts
Fourth, the table slides into the press and is heated so that the Kydex® sheet becomes formable
Fifth, the dual action of the vacuum from below and pressure from above pushes and pulls it around the part when membrane pressing.
Finally, the table and parts then begin to cool and the table slides out of the press
   The foregoing methods to decorate Kydex® are expensive and limited. Thus, for the most part, products from this material are supplied in unadorned form even though a premium would certainly be provided for such parts with a host of different designs.

Laser etching offers an attractive way to decorate products. In order to process large work pieces, manufacturers have utilized XY tables where the laser is stationary and the work piece is moved by linear motors in small incremental steps in the X and Y directions. This method, however, severely reduces throughput. It is estimated that a laser of this linear-motor type would take several minutes per square foot to etch detailed graphic patterns on materials. For example, at this speed, it is estimated that it could take over an hour to laser etch a fine resolution graphic image on a three foot square granite countertop. Thus, the unit manufacturing costs are far too high to economically process such materials on a mass scale. Because of the inability of prior laser systems to provide a high resolution image over a large field size in a cost effective manner, commercial laser etching of large materials has yet to be realized.

Other methods of decorating large substrates have been tried with unsatisfactory results. Conventional printing technologies such as embossing are limited in graphic design and often produce unappealing aesthetics. Other processes such as sandblasting have the drawback of high cost and also poor resolution.

One drawback of articles made from or possessing a coating of PVC or PVC-wood composite is the difficulty of replicating, for example, a wood grain pattern or other naturally occurring pattern (e.g., granite or stone) in the article surface. The present inventors have proposed laser marking designs such as wood grain patterns into the surfaces of PVC articles.

Lasers have been employed to create identification marks, such as UPC barcodes, in products for managing inventories and tracking shipments of goods, and for providing point of sale pricing information. However, laser marking of polyvinylchloride (PVC) articles in particular can cause localized thermal degradation of the article in the form of discoloration. Typically, high energy exposure of a PVC article to a laser beam will mar the article with an orange, yellowish or reddish tint. It is generally believed that the mechanism which causes the discoloration is “zip dehydrochlorination.” Thermal treatment of PVC with a laser causes evolution of hydrogen chloride, due to elimination of the hydrogen chloride from the PVC backbone. As the hydrogen chloride is eliminated, conjugated polyene sequences of more than four double bonds form in the backbone. The resulting conjugated polyenes are highly reactive and prone to crosslink or cleave the polymer chain. The formation of conjugated polyenes is accelerated by the eliminated hydrochloric acid. The conjugated polyenes are chromophores capable of selective light absorption, and can produce discoloration of organic compounds such as PVC.

### SUMMARY OF THE INVENTION

According to a first aspect of the invention, there is provided a laser-markable acrylic and PVC composition (with Kydex® being one example) using a CO₂ laser. Unexpectedly, the acrylic/PVC material, sometimes known as Kydex®, was very responsive to the laser in that a distinctive mark could be applied to the material with the proper laser power and speed and thus, energy density per unit time. For further understanding about the concept of energy density per unit time, reference should be made to U.S. Pat. No. 5,990,444, the disclosure of which is incorporated by reference. One embodiment is then to use such a laser mark to differentiate a laser etched graphic or pattern from the base material. Another embodiment is to use a 500 to 2,500 watt CO2 laser to provide a raster or vector graphic pattern on the Kydex® finished part. Yet another embodiment is to use a 500 to 2,500 watt CO₂ laser to provide a seamless raster or vector graphic pattern on a large piece of Kydex® which can then be cut and divided into multiple finished parts. In this case, an embodiment would include providing the necessary software and process controls to insure that the seams between individual parts that make up a larger part are without lines of demarcation.

The acrylic and PVC composition may include at least one discoloration control additive present in an effective amount to control discoloration that otherwise is caused by laser marking the polyvinylchloride of the composition, i.e., without the discoloration control additive.

A second aspect of the invention provides a method of laser marking an article, in which a laser-markable PVC surface of the article is irradiated with a laser beam to laser mark the surface and form a mark discernible to the naked eye, while controlling color change of the surface.

In another aspect of the invention, the laser engraving of the first plurality of lines and the laser engraving of the second plurality of lines can be controlled in one or a combination of ways to reduce the visual impact of the demarcation line or “seam” between different lased areas. In one embodiment, controlling comprises staggering the first plurality of lines with the second plurality of lines by adjusting the lengths of the first plurality of lines and the second plurality of lines. By staggering the first component section and the second component section, the demarcation line can take on a more curvilinear shape, as opposed to the straight line of a non-staggered application of the graphic. A more curvilinear demarcation line may reduce the visual impact of the demarcation line, and thus creating a higher quality product.

These and other aspects of the invention will become more apparent from the accompany drawings and the following detailed description of exemplary embodiments of the invention.

### BRIEF DESCRIPTION OF THE DRAWINGS

The accompanying drawings are incorporated in and constitute part of the specification. The drawings, together with the general description given above and the detailed description of the exemplary embodiments and methods given below, serve to explain the principles of the invention. In such drawings:

FIG. 1 is a schematic view of a system for marking the surface of an acrylic/PVC material according to an embodiment of the invention; and

FIG. 2 is a schematic view of a system for marking the surface of an acrylic/PVC material according to another embodiment of the invention.

FIG. 3 is a flowchart of a method for staggered laser etch lines according to an embodiment of the invention.

FIG. 4 is a schematic view of a system for staggered laser etch lines according to another embodiment of the invention.

FIG. 5A is a schematic view of a system for staggered laser etch lines according to another embodiment of the invention.

FIG. 5B is a schematic view of a system for scribing staggered laser etch lines in a continuous “print-on-the-fly” process according to another embodiment of the invention.

FIG. 5C is a schematic view of a system for staggered laser etch lines where multiple lasers are utilized to create the graphic according to another embodiment of the invention.

FIG. 5D is a schematic view of a system for staggered laser etch lines where the laser scan head is moved according to another embodiment of the invention.

FIG. 5E is a schematic view of a system for surfacing making an article with both a laser and a printer according to another embodiment of the invention.

FIG. 6 is a schematic view of a printing station for staggered laser etch lines according to another embodiment of the invention.

FIG. 7 is a schematic view of a printer applying ink and laser scribing to an article having a channel feature according to another embodiment of the invention.

FIG. 8 is an illustration of a Kydex® product laser etched with an alligator skin design.

FIG. 9 is an illustration of a government seal that is lazed into a Kydex® substrate.

FIG. 10 is an illustration of a company logo that is lazed into a Kydex® substrate.

### DETAILED DESCRIPTION OF EXEMPLARY EMBODIMENT(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the exemplary embodiments and methods.

The terms graphic and graphic design include but are not limited to decorative and artistic designs, non-decorative designs, simulated animal skin designs, patterns, graphic images, wood grain, alpha-numeric characters, corporate and trade logos, and other identifications such as UPC codes, etc.

The term “laser mark” used herein means to irradiate an article, including one made from Kydex®, with a laser beam to form a graphic design. In the course of marking, the laser beam causes a visually perceptible change to the component surface. The change may involve removal, ablation, etching, engraving, or change of color of a coating or the body of the article. The result is a visually-perceptible graphic mark in the article. As used herein, “in the article” includes laser marking the surface of the article, such as changing the article surface without necessarily engraving into the surface.

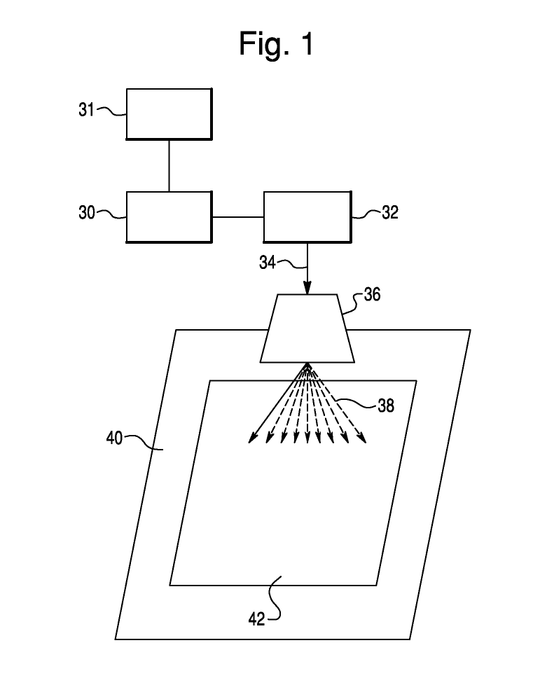

A system for marking components such as a Kydex® aircraft interior structure using a high-speed, high-power laser is shown in FIG. 1. The high-power laser is represented by reference numeral 32 in FIG. 1. The output 34 of the laser 32 is coupled to a scanning head 36, which includes a controllable, movable relatively light-weight coated mirror that is capable of scanning the laser output at a relatively high speed. The laser output 38 can be scanned across the work piece 42 on working surface 40, such as a table. Work piece 42 may be an aircraft interior, mass transit, corporate exhibits and displays, store fixture components, medical products, electrical equipment components, kiosk housings, contract furniture, protective wall covering systems, firearm holsters, knife sheaths, safety helmets, food equipment components, clean room walls and ceilings, military gear, building component or other substrates formed from an acrylic PVC composition.

The system includes a controller, designated by reference numeral 30 in FIG. 1. Control information for controlling the laser may be stored in advance in the controller 30. The stored control information may be linked to one or many different graphics, e.g., patterns. The controller 30 is capable of keeping up with the high scan speeds produced by the lightweight mirrors and making the necessary power changes at the specified speed. To create fine resolution graphics, the controller makes those power changes at high rates, such as every few millimeters of beam scan. The scan speed of the laser will determine the amount of power changes within the graphic. The type (e.g., complexity and intricacy) and depth of the graphic will also influence how the graphic is marked on the work piece.

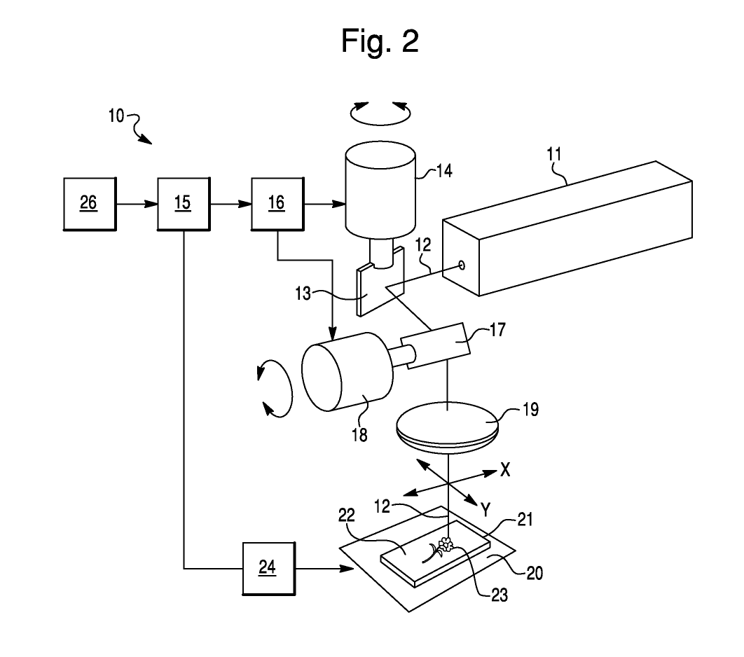

FIG. 2 illustrates another embodiment of a system for marking materials, such as building components. The system, generally designated by reference numeral 10, includes a laser 11 for generating a laser beam 12 in a direction of a computer-controlled mirror system. The illustrated mirror system also includes an x-axis mirror 13 rotatably mounted on and driven by an x-axis galvanometer 14. The x-axis galvanometer 14 is adapted to rotate and cause the rotation of the x-axis mirror 13. Rotation of the x-axis mirror 13 while the laser beam 12 is incident on the mirror 13 causes the laser beam 12 to move along the x-axis. A (numerical) control computer 15 controls the output of a power source 16 to control the x-axis galvanometer's 14 rotation of the x-axis mirror 13. The laser beam 12 is deflected by the x-axis mirror 13 and directed toward a y-axis mirror 17 rotatably mounted on y-axis galvanometer 18. The y-axis galvanometer 18, which is also powered by the power source 16, is adapted to rotate and cause rotation of the y-axis mirror 17. Rotation of the y-axis mirror 17 causes movement of the laser beam 12 incident on mirror 17 along the y-axis. The control computer 15 controls the output of the power source 16 delivered to y-axis galvanometer 18 for controlling rotation of the y-axis galvanometer 18 and the mirror 17.

The laser beam 12 is deflected by the y-axis mirror 17 and directed through a focusing lens 19 adapted to focus the laser beam 12. The lens 19 may be a multi-element flat-field focusing lens assembly, which optically maintains the focused spot on a flat plane as the laser beam 12 moves across the material to laser mark a graphic. The lens 19, mirrors 13, 17 and galvanometers 14, 18 can be housed in a galvanometer block (not shown).

The apparatus 10 further includes a working surface 20 which can be a solid support such as a table, or even a fluidized bed. A Kydex® material (or work piece) 21 is placed on the working surface 20. The Kydex® material 21 includes a viewable, laser-markable surface 22 to be laser marked. The working surface 20 may be adjusted vertically to adjust the distance from the lens 19 to the laser-markable surface 22 of the Kydex® material 21. The laser beam 12 is directed by the mirrors 13, 17 against the laser-markable surface 22 of the Kydex® material 21. Usually the laser beam 12 is directed generally perpendicular to the laser-markable surface 22, but different graphics can be achieved by adjusting the angle between the laser beam 12 and the laser-markable surface 22, for example, from about 45° to about 135°. Relative movement between the laser beam 12 in contact with the laser-markable surface 22 of the Kydex® material 21 causes a graphic design 23 to be scribed on the Kydex® laser-markable surface 22. The movements and timing of the mirrors 13, 17 and the power of the laser beam 12 are controlled by the numerical control computer 15 to scribe the specific desired graphic 23. As referred to herein, relative movement may involve movement of the laser beam 12 (e.g., using the mirror system 13, 17) as the Kydex® material 21 remains stationary, movement of the Kydex® material 21 while the laser beam 12 remains stationary, or a combination of simultaneous movement of the laser beam 12 and the Kydex® material 21 in different directions and/or at different speeds.

A second computer such as a work station computer (31 in FIG. 1; 26 in FIG. 2) can be used in the method to facilitate the formation of the desired graphic.

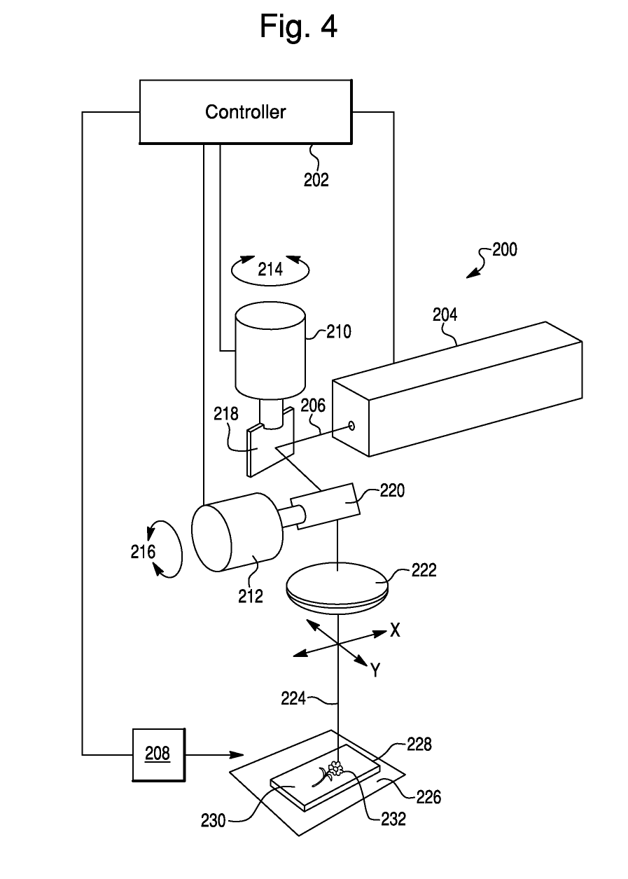

The following table provides the preferred operating parameters for the CO₂ laser system described herein, including the control system described below with respect to FIGS. 4-7, when utilizing a raster-based program.

| RASTER | GENERAL | PREFERRED | OPTIMAL |
|---|---|---|---|
| Scan Speed | 5-40 | 7-15 | 10 |
| (meter/s) | | | |
| Jump Speed | 10-40 | 25-35 | 30 |
| (meter/s) | | | |
| Frequency (Hz) | 10-70 | 40-65 | 60 |
| Duty Cycle | 27-85 | 27-50 | 27 |
| % of 100 | | | |
| Power | 40-100 | 45-70 | 50 |
| % of 2500 W | | | |

For the foregoing parameters, the jump speed refers to the speed at which the laser jumps from one line to another; i.e., after a laser scans a line, it must jump to the next section to start lasing. This is referred to a jump speed. Duty cycle is the fraction of time the laser is active or “on” during a scan.

The following table provides the preferred operating parameters for the CO₂ laser system described herein, including the control system described below with respect to FIGS. 4-7, when utilizing a vector-based program.

| VECTOR | GENERAL | PREFERRED | OPTIMAL |
|---|---|---|---|
| Scan Speed | 1-10 | 2-4 | 2 |
| (meter/s) | | | |
| Jump Speed | 1-10 | 1.5-4 | 2.5 |
| (meter/s) | | | |
| Frequency (Hz) | 10-30 | 15-25 | 20 |
| Duty Cycle | 27-85 | 27-50 | 27 |
| % of 100 | | | |
| Power | 25-100 | 27-40 | 30 |
| % of 2500 W | | | |

For the foregoing parameters, the jump speed again refers to the speed at which the laser jumps from one line to another; i.e., after a laser scans a line, it must jump to the next section to start lasing. This is referred to a jump speed. Duty cycle is the fraction of time the laser is active or “on” during a scan.

According to an implementation, the graphic design to be laser marked in the work pieces is created using Adobe® Illustrator or any similar vector based rendering program. Generally, the features that are etched using vector-based programs include lines and curves that define the outlines of the graphic and its major linear and curved features. The vector-based rendering program AutoCAD® developed by AutoDesk®, Inc. may be employed for this task. In order to make special features such as contour fills that are either difficult or impossible to prepare with AutoCAD®, the additional vector-based program Cutting Shop of Arbor Image Corp. may be used. Cutting Shop is a commercially available product of Arbor Image Corp. promoted for cutting and engraving applications. The raster-based program Technoblast® from Technolines LLC can create computer readable instructions for controlling the laser path and power for marking certain features. The raster- and vector-based program Exodus is used to receive the files from TechnoBlast® programs into a .tbf graphic (raster) file for the laser controller. Lasers are typically equipped with appropriate software to convert computer files into the laser manufacturer's language.

According to an exemplary implementation, a graphic image is scanned or otherwise input into the work station computer, converted into the proper format, e.g., digitized, and digital information corresponding to the lased features of the graphic image is introduced into the control computer with instructions to laser mark graphic design sections into their corresponding elements. The control computer controls movement of the galvanometers 14, 18 and the associated mirrors 13, 17 and the power output of the laser 11 to mark the first graphic element on the working surface of the work piece 21 at the appropriate power, movement velocity for high throughput, and beam spot site. At the same time, controllers and the workstation coordinate the relative movement and output of the laser with the movement of the article along the support 20. The laser controller will also control transverse movement of the laser beam. The power, beam size, and scan speeds may be selected depending upon the work piece material and intricacy of the graphic design. It may be preferable to avoid undesirable consequences of over-treatment, such as complete carbonization, burn-through and/or melting of the work piece, or under-treatment where the graphic image is not visible or only partially visible. The system can also include a tank 24 to inject a gas such as an inert gas into the working zone for cooling purposes. The amount of gas can be controlled by the work station computer 26, 31, laser controller, or other apparatus.

The work station computer 26, 31 may be, for example, a personal computer system. Computer hardware and software for carrying out the embodiments of the invention described herein may be any kind, e.g., either general purpose, or some specific purpose such as a workstation. The computer may be a Pentium® class or multi-core processor computer, running for example Windows XP®, Windows Vista®, or Linux®, or may be a Macintosh® computer. The computer may also be a handheld computer, such as a PDA, cellphone, or laptop. The programs may be written in C, or Java, Brew or any other programming language. The programs may be resident on a storage medium, e.g., magnetic or optical, of, e.g., the computer hard drive, a removable disk or media such as a memory stick or SD media, or other removable medium. The programs may also be run over a network, for example, with a server or other machine sending signals to one or more local machines, which allows the local machine(s) to carry out the operations described herein.

It should be understood that methods of the present invention may be carried out using various other laser systems having alternative layouts and components to those shown in FIGS. 1 and 2.

While this invention has been described with reference to the specific acrylic and PVC composition, commonly named Kydex®, it will be understood that other examples of acrylic/polyvinylchloride (PVC)-composite compositions may define the substrate for laser-etching as described by this invention.

It is further noted that the acrylic/PVC composition forming the substrate may be modified with a discoloration control agent according to exemplary embodiments of the invention for the purpose of controlling color change. In exemplary embodiments of the invention Kydex® is present at least in a laser-markable surface region of the article, although the Kydex® may be distributed throughout the entire body of the article to be marked, i.e., part or the entirety of the article may include the acrylic/PVC composition. For example, the article may comprise a compilation of a Kydex® part/section and a Kydex-free part/section.

According to one embodiment of the invention, a laser-markable composition includes acrylic and polyvinylchloride and may further include a hydrogen chloride scavenger. The hydrogen chloride scavenger reacts with hydrogen chloride which is generated or evolved due to polyvinylchloride dechlorination caused by laser irradiation. The hydrogen chloride scavenger may be included in an effective amount to eliminate or at least substantially reduce discoloration caused by the evolved hydrogen chloride. The effective amount will vary, depending upon the scavenger selected. The scavenger may be heat activated by the laser. The scavenger may be distributed throughout the Kydex® article, or the scavenger may be included exclusively in the Kydex® surface layer or coating region which is to be laser marked. Calcium carbonate is an example of a suitable scavenger, and may be incorporated in the composition in an amount of about 5 parts per hundred part of resin (phr) to about 35 phr or beyond this range. Another example of a scavenger is epoxidized soybean oil. An effective amount of epoxidized soybean oil may range, for example, from about 2.0 to about 27.0 phr or beyond this range.

Another embodiment of the invention provides a laser-markable composition including acrylic/polyvinylchloride composition and an antioxidant. It is believed that antioxidants scavenge free radicals and suppress peroxide formation from attack of oxygen, particularly at elevated temperatures. The antioxidant may be present in the laser-markable surface area of the article in an effective amount to control or substantially reduce discoloration caused by laser irradiation. The effective amount will vary, depending upon the antioxidant selected. The antioxidant may be distributed throughout the Kydex® article or may be limited to the Kydex® surface layer or evenly applied as a coating of the article. An example of an antioxidant is octadecyl-3-(3,5-ditertbutyl-4-hydroxyphenyl)-propionate (commercially available as Irganox 1076 produced by Ciba-Geigy), which may be present in an amount of, for example, about 0.1 to about 0.4% dry weight of PVC formula.

According to yet another embodiment of the invention, a laser-markable composition includes acrylic/polyvinylchloride composition and a heat stabilizing agent for managing heat development when the composition is exposed to a laser. The heat stabilizing agent may be present in the laser-markable surface area of the article in an effective amount to eliminate or substantially reduce the discoloration caused by the heat of laser irradiation. The effective amount will vary, depending upon the heat stabilizing agent selected. The heat stabilizing agent may be distributed throughout the Kydex® article or may be limited to the Kydex surface layer or applied as a coating to the article. An example of a heat stabilizing agent suitable for this embodiment is a tin stabilizer, such as butyl tin mercapttide, which may be used in an amount of, for example, about 0.5 to about 2.5 phr or beyond this range. Another example of a heat stabilizing agent is benzotriazole, which may be present, for example, in an amount of about 2 to about 10 phr or beyond this range.

Additionally, iron oxide, dyes and pigments are examples of color control agents for controlling the color of the irradiated article. For example, titanium dioxide in an amount of, e.g., about 5 to about 10 phr or beyond this range may be selected. Mica may be selected as filler, for example, in an amount of about 5 to about 35 phr or beyond this range. Heat sensitive inorganic iron oxide may be present in an amount of, for example, about 1 to about 15% dry weight of laser active coating formulation.

Combinations of the above embodiments may also be practiced to control color change for the Kydex® article. The laser-markable composition may contain a combination of any two or more of the hydrogen chloride scavenger(s), the antioxidant(s), the heat stabilizing agent(s), and the laser-activated color control agent(s).

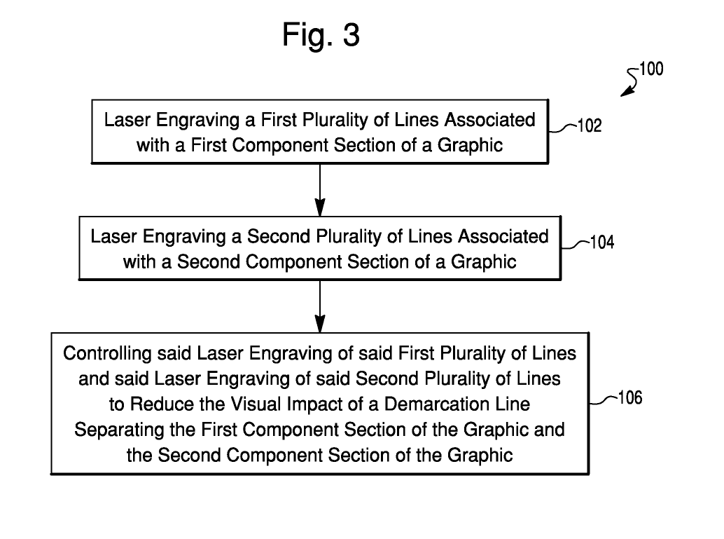

FIG. 3 is a flowchart of a method for staggered laser etch lines according to an embodiment of the invention. As shown in FIG. 3, the method 100 begins with laser engraving a first plurality of lines associated with a first component section of a graphic 102. A laser engraved graphic typically consists of multiple lines laser etched on or into a surface. Together, in aggregate, the plurality of etched lines reproduce the overall appearance, or effect, of the graphic.

Next, the method 100 continues with laser engraving a second plurality of lines associated with a second component section of a graphic 104. A graphic may be divided into two or more component sections. For example, in order to etch a graphic greater in at least one dimension than the field size of a laser, than multiple component sections can be used to etch the graphic on the surface of an article. One or more lasers may laser engrave the first plurality of lines and/or the second plurality of lines.

Various techniques may be used to align the multiple component sections to provide a high quality image. In one embodiment, after a first section of the graphic is laser engraved, a position of the laser engraved first section is indexed, and the second section of the graphic is laser engraved beginning at the indexed position. In another embodiment, after a first component section of the graphic is laser engraved, the laser scanning head is moved to a location adjacent to the laser engraved first component section,

Finally, the method 100 concludes by controlling the laser engraving of the first plurality of lines and the laser engraving of second plurality of lines to reduce the visual impact of a demarcation line separating the first component section of the graphic and the second component section of the graphic 106.

The laser engraving of the first plurality of lines and the laser engraving of the second plurality of lines can be controlled in one or a combination of ways to reduce the visual impact of the demarcation line. In one embodiment, controlling comprises staggering the first plurality of lines with the second plurality of lines by adjusting the lengths of the first plurality of lines and the second plurality of lines. By staggering the first component section and the second component section, the demarcation line can take on a more curvilinear shape, as opposed to the straight line of a non-staggered application of the graphic. A more curvilinear demarcation line may reduce the visual impact of the demarcation line, and thus creating a higher quality product.

Controlling the laser engraving of the first plurality of lines and the laser engraving of the second plurality of lines can also include randomizing the laser engraving of at least one of the first plurality of lines and the second plurality of lines by partitioning the lines into a random number of random length sub-unit lengths, controlling the line per inch density of the first plurality of lines and the second plurality of lines, and/or controlling the laser power of the laser engraving of the first plurality of lines and the second plurality of lines.

FIG. 4 is a schematic view of a system for staggered laser etch lines according to another embodiment of the invention. As shown in FIG. 4, the system 200 is configured to laser etch graphics onto a surface. The system 200 comprises a controller 202 in communication with the laser 204 and gas tank 208.

The laser 204 generates a laser beam 206. The laser beam 206 output from the laser 204 may be adjusted from 500 watts up to 2,500 watts or more. The laser beam 206 may be directed and/or manipulated by x-axis mirror 218 and/or y-axis mirror 220. An x-axis galvanometer 210 is in communication with x-axis mirror 218, and can rotate x-axis mirror 218 in the direction of 214 to direct the laser beam 206 along the x-axis. As the x-axis mirror 218 is rotated, laser beam 206 may be directed along the x-axis. Similarly, a y-axis galvanometer 212 is in communication with the y-axis mirror 220, and can rotate y-axis mirror 220 to further direct laser beam 206. As the y-axis mirror 220 is rotated, laser beam 206 may be directed along the y-axis. The controller 202 can be configured to control the x-axis galvanometer 210 and the y-axis galvanometer 212 by manipulating the power provided to each galvanometer 210, 212.

After the laser beam 206 is directed by the x-axis mirror 218 and the y-axis mirror 220, the laser beam 206 travels through a focusing lens 222. The focusing lens can be configured to focus the laser beam 206 into a directed laser beam 224 onto a surface 230 of a workpiece 228. The focusing lens 222 may be a multi-spot on a flat plane as the laser beam 206 moves across the workpiece 228 to scribe a graphic. One or more of the focusing lens 222, x-axis galvanometer 210, y-axis galvanometer 212, x-axis mirror 218 and/or y-axis mirror 220 can be housed in a galvanometer block (not shown).

The system 200 further comprises a working surface 226. Working surface 226 may comprise a solid substrate such as a table, or even a fluidized bed. One or more workpieces 228 to be laser etched are placed on the working surface 226. The workpiece 228 includes a surface 230 for laser-etching and/or printing.

The position of the workpiece 228 and the surface of the workpiece 230 may be adjusted in a variety of ways. The working surface 226 may move vertically to adjust the distance from the focusing lens 222 to the workpiece surface 230. The working surface 226 may comprise a conveyer belt capable of horizontal movement.

As the x-axis mirror 218 and the y-axis mirror 220 move, or rotate, the focused laser beam 224 is directed across the surface 230 of the workpiece. In some embodiments, the focused laser beam 224 hits the surface 230 of the workpiece 228 at a perpendicular, i.e. 90° angle. Variations in the laser-markings on the surface 230 may be achieved by adjusting the angle of incidence of the focused laser beam 224 on the surface 230, such as between angles of about 45° to about 135°.

As the focused laser beam 224 contacts and moves about the surface 230 of the workpiece, a graphic 232 is laser-etched onto the surface 230. The movements and timing of the mirrors 218, 220 and the power of the laser beam 206 can be controlled by the control computer 202 to laser-etch a specific graphic 232. As referred to herein, relative movement may involve movement of the focused laser beam 224 (e.g., using the mirror system) as the workpiece 228 remains stationary, movement of the workpiece 228 while the directed laser beam 224 remains stationary, or a combination of simultaneous movement of the laser beam 224 and the workpiece 228 in different directions and/or at different speeds.

The control computer 202 and/or a second computer (not shown in FIG. 4) may be used to form a desired graphic. For example, a graphic can be scanned into a second computer, converted into the proper format, and then communicated to the control computer 202. The control computer then controls the galvanometers 210, 212, mirrors 218, 220, and the power output of the laser 206 to form the graphic 232 on the surface 230 of the workpiece 228.

The system 200 can also include a tank 208 to inject a gas such as an inert gas into the working zone. The amount of gas can be controlled by the numerical control computer or by other means. The power and speeds should be controlled to effect the desired color change while avoiding undesirably consequences of over-treatment, such as complete carbonization, burn-through and/or melting of the workpiece 228.

It is noted that the system described with reference to FIG. 4 is equally suited to perform the operations described with respect to FIGS. 1 and 2.

Computer hardware and software for carrying out the embodiments of the invention described herein may be any kind, e.g., either general purpose, or some specific purpose such as a workstation. The computer may be a Pentium® or higher class computer, running an operating system such as Windows XP®, Windows Vista®, or Linux®, or may be a Macintosh® computer. The computer may also be a portable or mobile computer, such as a PDA, cell phone, or laptop. The programs may be written in source code, C, C plus, Java or any other programming language. The programs may be resident on a storage medium, e.g., magnetic or optical, of, e.g., the computer hard drive, a removable disk or media such as a memory stick or SD media, or other removable medium. The programs may also be run over a network, for example, with a server or other machine sending signals to one or more local machines, which allows the local machine(s) to carry out the operations described herein.

In the course of marking and scribing, the laser beam 224 applies heat to the plastic composite working surface of the substrate, thereby causing a visually perceptible change to the substrate surface, such as by causing removal, ablation, or etching of a coating of the substrate, removal, ablation or etching of substrate material, transformation of a dye such as by dye removal or alteration of the color of the dye, etc. The result is a visually-perceptible graphic marking on or in the substrate. The term graphic refers to decorative and artistic designs, non-decorative designs, patterns, graphic images, simulated wood grain, alpha-numeric characters, logos, other markings, etc. It should be understood that the methods and systems described herein may be used for marking/scribing materials other than plastic lumber or other building materials.

It should be understood that the present invention may be carried out using various other laser systems having alternative layouts and components to those shown in FIGS. 3 and 4, or as otherwise generally described above. The laser scanning system configuration can be pre-objective architecture where the laser beam is reflected from two scan mirrors and then directed through a focusing lens. Alternately, the laser scanning system architecture can be post-objective where the laser beam is first passed through the focusing lens and then reflected from the scan mirrors onto the work piece. Any number of optics and lenses can be introduced into either architecture. Examples of other such laser systems are disclosed in U.S. Patent Application Publication No. 2007/0108170, to Costin et al., which is hereby incorporated by reference.

Other embodiments of the invention combine ink-jet printing with laser scribing. In certain exemplary embodiments of the invention a method is provided for marking the surface of an article in which a first graphic design element is laser scribed into the article surface, and a second graphic design element is printed on the surface of the article. The first and second graphic design elements are applied to the article surface in registry with one another so that the overall graphic design is a cooperative interaction between the lased and printed elements. Spatially, registering the first and second graphic elements may involve their superimposition or juxtaposition on the article surface using, for example, predetermined coordinates. Aesthetically, the lased and printed graphic design elements produce a synergistic effect that in exemplary embodiments is manifested as a high quality simulation of natural materials that could not be attained by either laser marking or printing without the other. In certain exemplary embodiments the first and second graphic design elements may also produce a textural contrast as discussed below. Laser scribing and printing may be conducted in any order or simultaneously, although preferably the substrate is lazed first and ink-jet printed second.

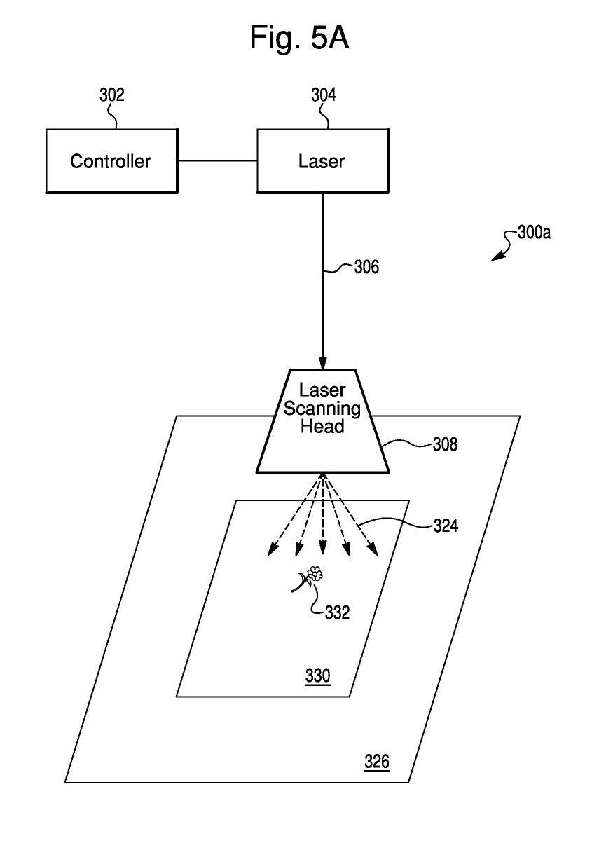

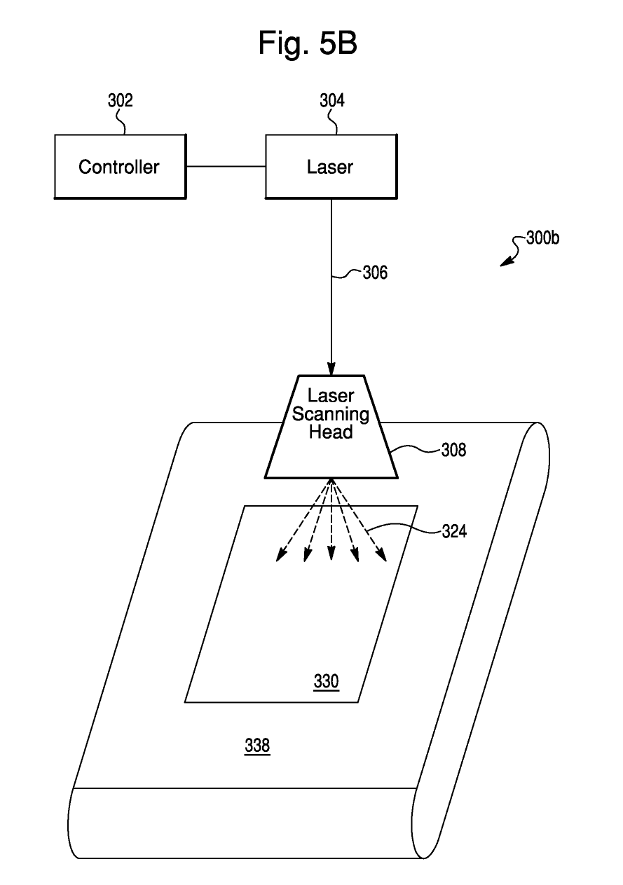

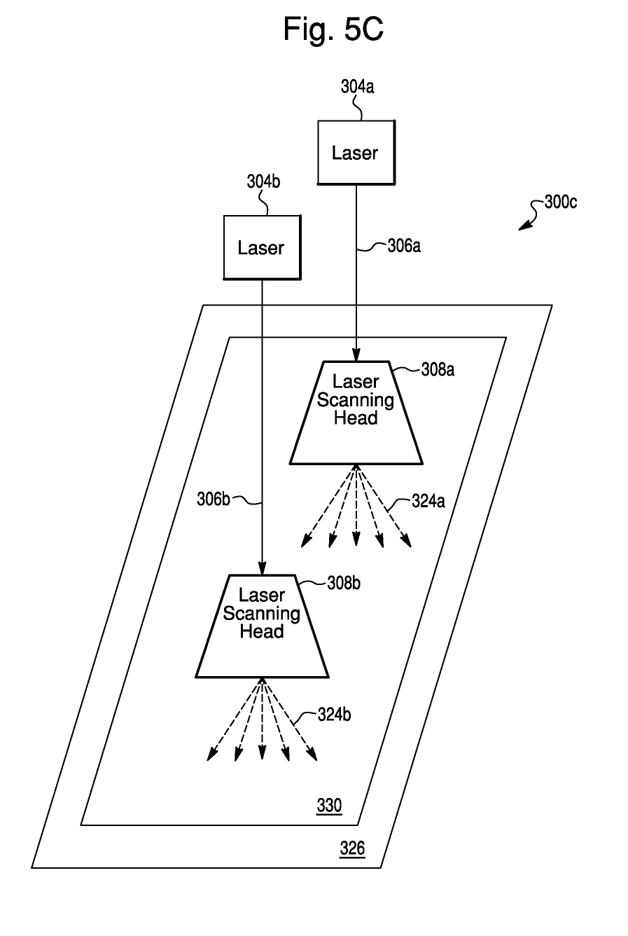

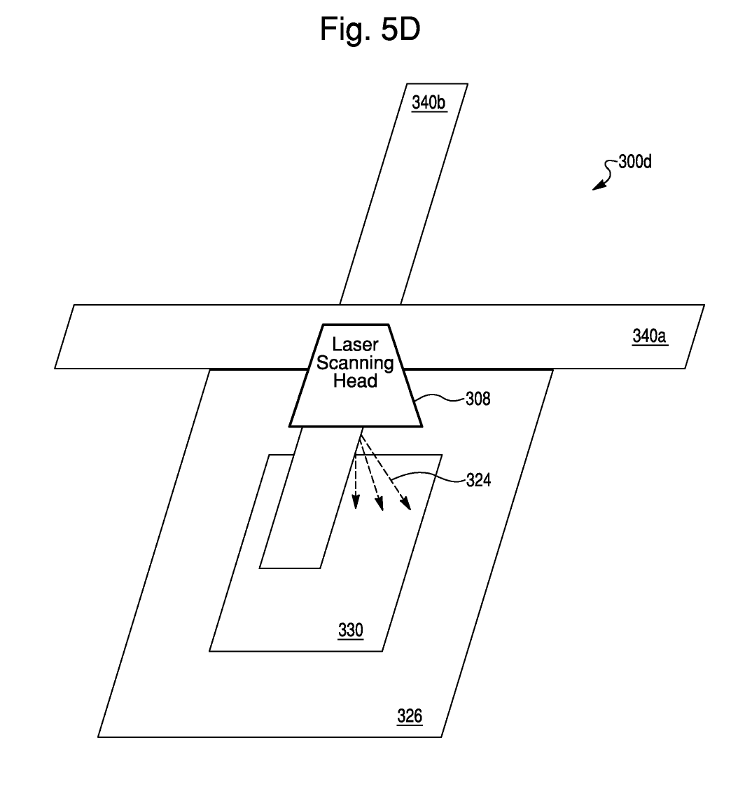

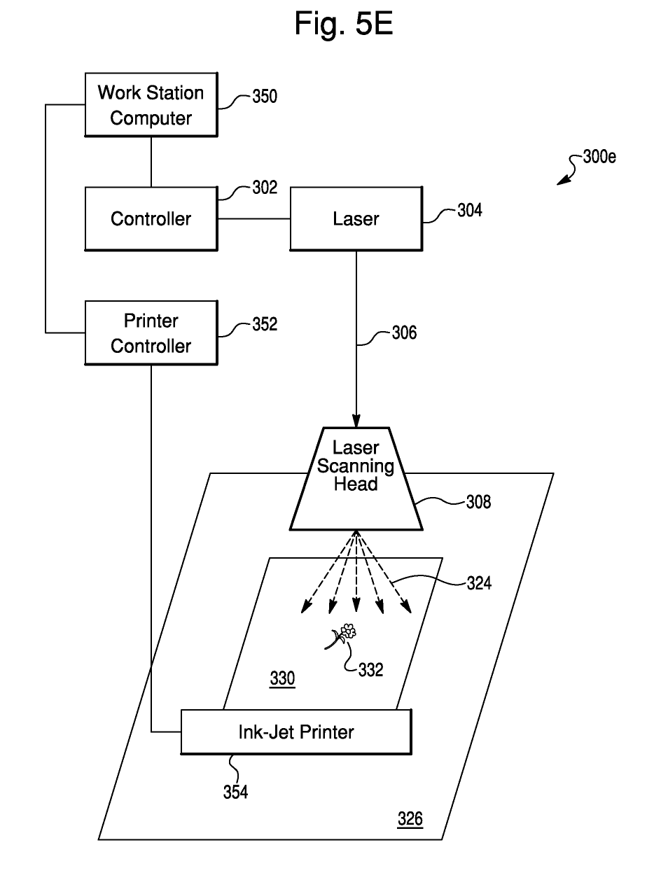

FIG. 5A is a schematic view of a system etching for staggered laser etch lines according to another embodiment of the invention. Articles according to the invention may be marked using a high-speed high power laser system 300 such as shown in FIG. 5A. The laser 304 may be a high power laser, such as a CO 2 laser of at least 500 watts and up to 2500 watts or more. The output 306 of the laser 304 is coupled to a laser scanning head 308. The laser scanning head 308 includes a relatively light-weight coated mirror that is capable receiving the output 306 generated by the laser 304 and generating a directed laser beam 324 at a relatively high speed. The directed laser output 324 can be scanned across the work piece 330 on working surface 326. The workpiece 330 may comprise a plastic lumber building component or some other material.

As shown in FIG. 5A, the system 300a includes a controller 302. The controller 302 may store control information for controlling the laser before, during, and/or after the laser engraving process. The control information may be linked to one or many different graphics, such as a wood grain pattern, or a floral pattern 332. The controller 302 is capable of keeping up with the high scan speeds of the laser scanning head 308 produced by the lightweight mirrors and able to make the necessary power changes at the specified speed. To create fine resolution graphics, the controller 302 can make such power changes at high rates, such as 10,000 to 50,000 power changes per second. The type (e.g., complexity and intricacy) and depth of the graphic will also influence how it is scribed on the substrate.

FIG. 5B is a schematic view of a system for scribing staggered laser etch lines in a continuous “print-on-the-fly” process according to another embodiment of the invention. As shown in FIG. 5B, the system 300b comprises a conveyer apparatus 338. The conveyer apparatus 338 can move, or convey the work piece 330 under the directed laser 324. The speed of the conveyor apparatus 338 may be fixed, or predetermined. Or, the controller 302 may continuously set and maintain the proper speed of the conveyer apparatus to assure accurate registration of the component sections that collectively comprise the graphic being applied. In one embodiment, the conveyor apparatus 338 is a roller based table where the workpiece is pulled along the conveyor by means of a nip roll system.

FIG. 5C is a schematic view of a system for staggered, laser-etch lines where multiple lasers are utilized to create the graphic according to another embodiment of the invention. As shown in FIG. 5C, the system 300c comprises a plurality of lasers 304a, 304b. One or more laser controllers 302 (not shown in FIG. 5C) may control the plurality of lasers 304a, 304b. A plurality of laser scanning heads 308a, 308b are in communication with the plurality of lasers 304a, 304b, and laser engrave graphics onto the article 330 by generating directed laser beams 324a, 324b. While each laser 304a, 304b may have its own controller, a single master controller may control all lasers 304a, 304b, or control individual controllers. By using multiple lasers, each laser 304a, 304b may apply a component section, or portion, of the graphic. In order to assure a unitary, uniform composite image, each component section may be in registration.

FIG. 5D is a schematic view of a system for staggered laser etch lines where the laser scan head is moved according to another embodiment of the invention. As shown in FIG. 5D, the system 300d comprises laser scanning head 308 operably connected to a first track 340a and a second track 340b. The laser scanning head 308 can move along the tracks 340a, 340b so that the work piece 330 may remain stationary on the support apparatus 326. The laser scanning head 308 may be carried on a rail, track, robot arm or similar system to allow the laser scan head 308 to move along the work piece 330 as it applies the graphic in portions onto the work piece. A plurality of component sections of the graphic applied by the laser scanning head 308 may be in registration to assure a unitary and uniform graphic applied to the work piece.

It should be understood that the present invention may be carried out using various other laser systems having alternative layouts and components to those shown in FIGS. 4 and 5A-5E, or as otherwise generally described above. It should be understood that methods of the present invention may be carried out using various other laser systems, such as the laser system disclosed in U.S. Patent Application Publication No. 2007/0108170, to Costin et al., which is hereby incorporated by reference.

Other embodiments of the invention may combine ink-jet printing with laser scribing. In certain exemplary embodiments of the invention a method is provided for marking the surface of an article in which a first graphic design element is laser scribed into the article surface, and a second graphic design element is printed on the surface of the article. The first and second graphic design elements are applied to the article surface in registry with one another so that the overall graphic design is a cooperative interaction between the lased and printed elements. Spatially, registering the first and second graphic elements may involve their superimposition or juxtaposition on the article surface using, for example, predetermined coordinates. Aesthetically, the lased and printed graphic design elements produce a synergistic effect that in exemplary embodiments is manifested as a high quality simulation of natural materials that could not be attained by either laser marking or printing without the other. In certain exemplary embodiments the first and second graphic design elements may also produce a textural contrast as discussed below. Laser scribing and printing may be conducted in any order or simultaneously, although preferably the substrate first is lazed and then ink-jet printed.

A system for laser scribing and ink printing graphic design on articles such as building components using a high-speed high power laser and ink jet printer is shown in FIGS. 5E, 6, and 7. It should be understood that the elements of the system described below are exemplary and are not necessarily intended to be limiting on the scope of the invention. Other systems and apparatus may be substituted for those described below, and the system and apparatus described below may be modified as dictated by the nature of the graphic pattern and the article.

FIG. 5E is a schematic view of a system for surfacing making an article with both a laser and a printer according to another embodiment of the invention. As shown in FIG. 5E, a system 300e comprises a work station computer 350. The work station computer 350 may be accessed by an operator, and receive input specifying one or more parameters related to a graphic to be laser engraved on an article. For example, a user may specify a specific graphic to be laser engraved on the surface of the article, along with a speed and a quality level. The work station computer 350 is in operative communication with the controller 302 and a printer controller 352. The controller 302 is in communication with the laser 304 and the laser scanning head 308 to direct the output of the laser 306. The printer controller 352 communicates with an ink-jet printing apparatus 354.

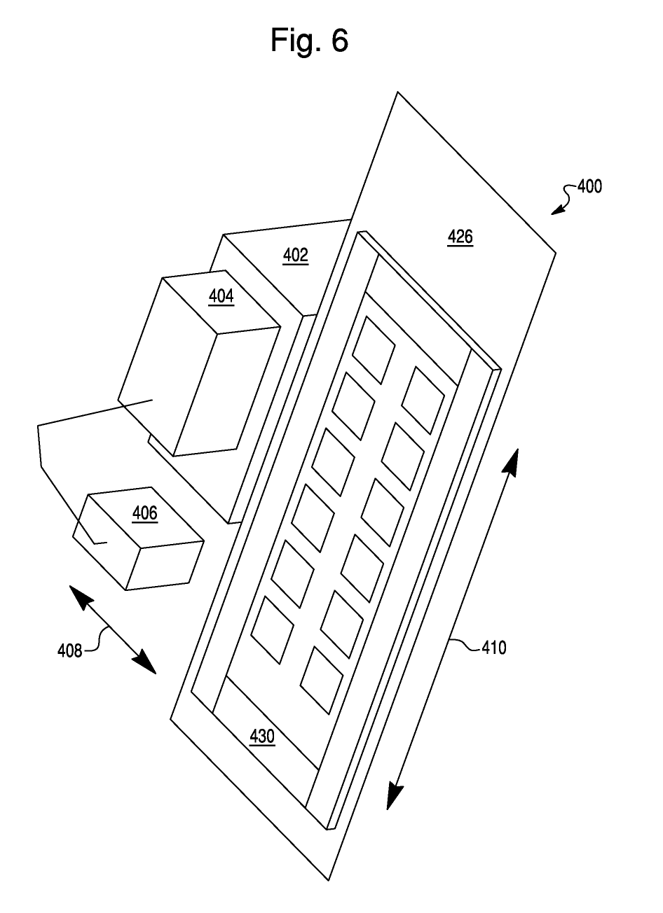

FIG. 6 is a schematic view of a printing station for staggered laser etch lines according to another embodiment of the invention. As shown in FIG. 6, the system 400 comprises a printing station 402. The printing station 402 includes an ink-jet printer 404 with at least one ink jet print head 406. The ink-jet print head 406 is mounted for horizontal movement in the direction of arrow 408, which is perpendicular to the direction of movement of the article 430 on the working surface 426, indicated by arrow 410. The ink jet print head 406 may move in the direction 408 across the entire width of the door structure 430. The printer 402 may be a flat-bed printer, such as available through Inca Digital Printers Limited of Cambridge, United Kingdom.

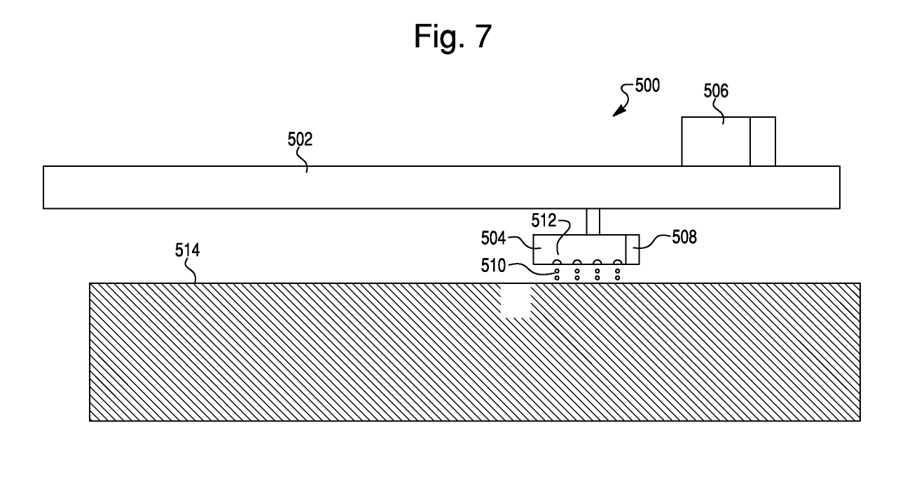

FIG. 7 is a schematic view of a printer applying ink and laser scribing to an article having a channel feature according to another embodiment of the invention. As shown in FIG. 7, a printer 500 is configured to print on a surface of an article 514. The printer 500 may include a rail 502 for supporting the print head 504. The rail 502 provides for lateral movement of the print head 504 under the control of the print controller 506. The print head 504 is shown with a UV curing lamp 508 for drying and curing the ink jet ink. Alternatively, a separate curing station (not shown) may be provided. Ink jet ink droplets 510 are emitted from one or more nozzles 512 of the print head 504.

It should be understood that the printer 500 may include multiple print heads 506 arranged in rows or arrays, so that each pass may effective print in more than one set of print grid positions. The nozzles 510 may emit droplets 510 of various desired colors in order to create a desired color. While the printing apparatus 500 described above is an ink jet printer, it should be understood that other printer types, such as laser printers, may be used.

An object of the invention is to reduce or eliminate the visual impact, i.e. visual perceptibility, of a demarcation line at the border between two adjoining component sections of a graphic which is laser engraved onto the surface of an article. This object is accomplished by controlling the laser engraving of the adjoining component sections, such as by staggering and/or randomizing the laser engraved lines associated with the two component sections. Staggering occurs at the border between the two component sections. Randomization of laser etched line sub-length occurs within each individual laser etched line in a component section within which it occurs. The concept can incorporate both staggering and the randomizing of the sub-lengths of the laser etch lines from one or both component sections with those from an adjoining component section. A more detailed description of randomization of laser etched lines sub-lengths is provided in U.S. patent application Ser. No. 12/768,122, filed Apr. 27, 2010, entitled “Staggered Laser-Etched Line Graphic System, Method and Articles of Manufacture,” which is hereby incorporated by reference in its entirety.

With the present invention, a host of distinctive graphics may be formed into a variety of Kydex® substrates which could be translated into totally new design aesthetics for the acrylic/PVC material. For example, the following designs could be generated from this invention:
Laser etched logos such as American Airlines® logo or the Lear Jet logo on Kydex® used for aircraft pull down trays, armrests, bulkhead laminates, window reveals, etc.
Laser etched advertisements on the side panels Kydex® used for mass transit and busses.
Wood grain and other patterns laser etched on Kydex® for store fixtures.
High Tech graphics laser etched on Kydex® for exhibit displays.
Alligator and exotic animal skins laser etched on Kydex® gun holsters and knife sheaths.
Camouflage patterns laser etched on Kydex® military gear.
Instructions laser etched on Kydex® medical supplies.
Company information laser etched on Kydex® used for kiosks.
Hospital and medical center logos laser etched on hospital bed headboards and footboards made from Kydex®.
Eye catching graphic patterns laser etched on Kydex® side panels and ceiling panels in subways, busses and trains.
Company logos laser etched on Kydex® used for food and electrical container equipment.
Textile patterns laser etched on Kydex® protective wall coverings.
Laser etched designs on floor mats made from Kydex®.
Laser etched graphics on Kydex® fire rated ceiling panels.

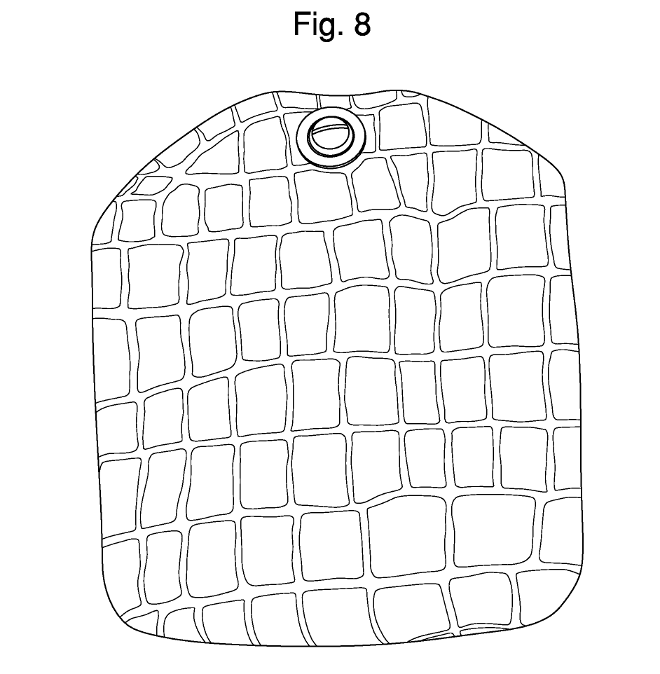

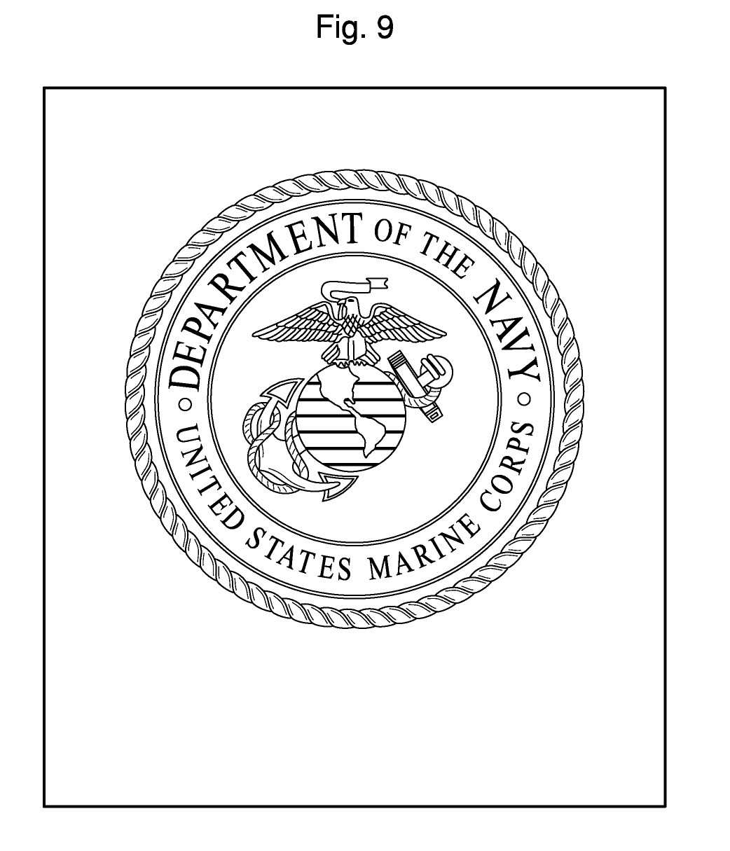

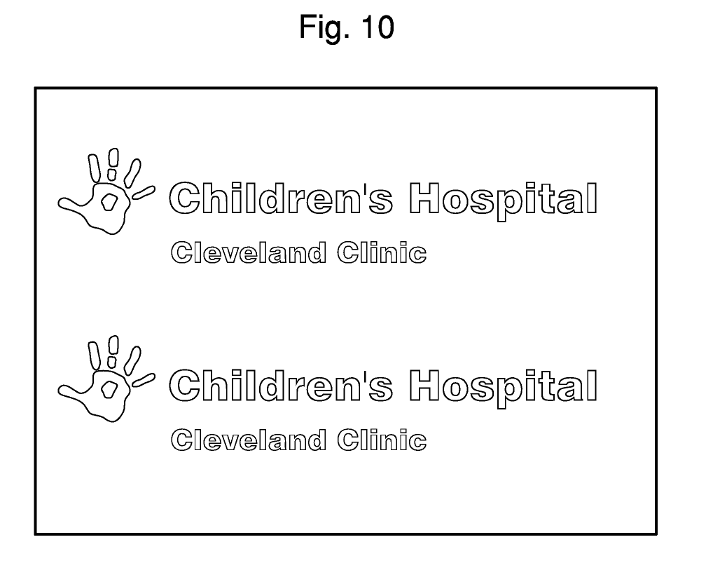

Examples of some of these images are attached as FIGS. 8-10, which illustrate an alligator skin image on a gun holdster (FIG. 8), a Marine Corps seal lazed into a Kydex® material (FIG. 9), and a Children's Hospital logo on an exhibit display made of Kydex®. Consequently, this invention considerably broadens the usefulness of Kydex® for almost every application. For example, laser etching an alligator skin pattern on Kydex® for gun holsters will allow the fairly inexpensive product to compete with expensive alligator skin leather holsters. Likewise, laser etching advertisements on side panels in subways and busses adds a new dimension and value for the product. Laser etching new graphic patterns on fire rated ceiling panels or protective wall coverings clearly add a premium to the product since it is transformed from plain unadorned substrate to an attractive new and desirable design.

From the above description, it will be understood that certain exemplary embodiments of the invention feature the patterning of articles with graphic designs laser engraved or otherwise laser marked in the component in such a way that the graphic design is viewable. The graphic may describe a pattern that is repeating such as a diamond, houndstooth or chevron pattern, for example, or may describe a non-repeating pattern that is organic, floral and/or natural in such a way that it does not repeat. The patterns and graphics may be as simple as geometric designs or highly complex. The inventive concept may permit the laser marking of advanced, highly aesthetic designs to allow manufacturers to offer premium products not now available in the marketplace.

Additional advantages and modifications will readily occur to those skilled in the art. Therefore, the invention in its broader aspects is not limited to the specific details, representative devices and methods, and illustrative examples shown and described.

What is claimed is:

1. A laser-markable article, comprising:
a composition formed of acrylic and polyvinylchloride; and
a series of laser markings formed into said acrylic/polyvinylchloride composition by a CO₂ laser to differentiate a laser-etched graphic or pattern applied to said composition from untreated portions of said composition.

2. The laser-markable article of claim 1, wherein said laser markings define one of a raster or vector graphic pattern.

3. The laser-markable article of claim 1, wherein said laser markings form lased areas having different degrees of width and depth ablation depending on energy supplied to said CO₂ laser.

4. The laser-markable article of claim 1, wherein said CO₂ laser is a 500 W to 2500 W CO₂ laser.

5. The laser-markable article of claim 1, wherein said series of laser marking are a different color than untreated areas of said composition.

6. The laser-markable article of claim 1, further comprising a discoloration control additive present in an effective amount to control discoloration caused by laser marking of the polyvinylchloride composition.

7. The laser-markable article of claim 6, wherein the discoloration control additive comprises at least one of a hydrogen chloride scavenger, an antioxidant, a heat stabilizing agent, and a color control agent.

8. The laser-markable article of claim 1, wherein said article comprises:
a first plurality of laser engraved lines associated with a first component section of a graphic;
a second plurality of laser engraved lines associated with a second component section sharing a border with said first component section of said graphic;
wherein the first plurality of lines and the second plurality of lines are controlled to reduce the visual impact of a demarcation line separating the first component section and the second component section.

9. The laser-markable article of claim 8, wherein said first plurality of laser engraved lines with said second plurality of laser engraved lines are staggered by adjusting the lengths of said first plurality and said second plurality of laser engraved lines.

10. A method of making a laser-marked article comprising:
providing a laser-markable composition comprising acrylic and polyvinylchloride; and
laser marking the laser-markable composition with a CO₂ laser.

11. The method of claim 10, wherein the step of laser marking comprises the step of changing a color of a portion of a surface of said composition by controlling an energy supplied to said CO₂ laser.

12. The method of claim 10, wherein the step of laser marking comprises the step of ablasing portions of said composition to provide areas having different degrees of width and depth ablation depending on energy supplied to said CO₂ laser.

13. The method of claim 10, further comprising the step of adding a discoloration control additive to said composition in an effective amount to control discoloration or color change caused by laser irradiation.

14. The method of claim 13, wherein the discoloration control additive comprises at least one of hydrogen chloride scavenger, an antioxidant, a heat stabilizing agent, and a color control agent.

15. The method of claim 10, further comprising the steps of:
laser engraving a first plurality of lines associated with a first component section of a graphic on a surface of said composition;
laser engraving a second plurality of lines associated with a second component section of the graphic on the surface of the composition; and
controlling said laser engraving of the first plurality of lines and said laser engraving of second plurality of lines to reduce the visual impact of a demarcation line separating the first component section of the graphic and the second component section of the graphic.

16. The method according to claim 15, wherein said controlling comprises staggering said first plurality of lines with said second plurality of lines by adjusting the lengths of said first plurality of lines and said second plurality of lines.

17. A laser-marked article formed from a laser-markable acrylic and polyvinylchloride composition comprising acrylic and polyvinylchloride and a discoloration caused by laser marking of the acrylic and polyvinylchloride composition.

18. The laser-marked article of claim 17, further comprising a discoloration control additive.

19. The laser-marked article of claim 18, wherein the discoloration control additive comprises at least one of a hydrogen chloride scavenger, an antioxidant, a heat stabilizing agent, and a color control agent.
